(19) United States
(12) Patent Application Publication
(10) Pub. No.: US 2013/0039296 A1
(43) Pub. Date: Feb. 14, 2013

(54) METHOD AND APPARATUS FOR SUPPORTING OPERATION ON DEPENDENT CARRIERS

(71) Applicants: Jelena M. Damnjanovic, Del Mar, CA (US); Peter Gaal, San Diego, CA (US); Yongbin Wei, San Diego, CA (US); Juan Montojo, Nuremberg (DE); Durga Prasad Malladi, San Diego, CA (US); Oronzo Flore, Ostuni (IT)

(72) Inventors: Jelena M. Damnjanovic, Del Mar, CA (US); Peter Gaal, San Diego, CA (US); Yongbin Wei, San Diego, CA (US); Juan Montojo, Nuremberg (DE); Durga Prasad Malladi, San Diego, CA (US); Oronzo Flore, Ostuni (IT)

(73) Assignee: QUALCOMM Incorporated, San Diego, CA (US)

(21) Appl. No.: 13/569,083

(22) Filed: Aug. 7, 2012

Related U.S. Application Data
(60) Provisional application No. 61/521,558, filed on Aug. 9, 2011.

(51) Int. Cl. H04W 72/04

(52) U.S. Cl. 370/329

(57) ABSTRACT

Techniques for supporting communication on multiple carriers are disclosed. In one design, a user equipment (UE) is configured with a base carrier and a dependent carrier linked to the base carrier. Data transmission on the dependent carrier is scheduled via a scheduling carrier, which is different from the dependent carrier. The UE receives a scheduling grant on the scheduling carrier and determines whether the scheduling grant is for the base carrier and/or the dependent carrier. The UE communicates (e.g., sends or receives data) on the base carrier and/or the dependent carrier based on the scheduling grant. The scheduling grant may be (i) a separate grant carrying scheduling information for only one carrier, (ii) a common grant carrying scheduling information for both carriers, (iii) a joint grant carrying separate scheduling information for each carrier, or (iv) a composite grant that may be a separate grant, a common grant, or a joint grant.

The present application claims priority to provisional U.S. Application Ser. No. 61/521,558, entitled “EXTENSION CARRIERS FOR WIRELESS COMMUNICATION,” filed Aug. 9, 2011, and incorporated herein by reference in its entirety.

### BACKGROUND

I. Field

The present disclosure relates generally to communication, and more specifically to techniques for supporting communication in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A wireless communication network may support operation on multiple carriers. A carrier may refer to a range of frequencies used for communication and may be associated with certain characteristics. For example, a carrier may be associated with system information and/or control information describing operation on the carrier. A carrier may also be referred to as a component carrier (CC), a cell, a serving cell, a frequency channel, etc.

### SUMMARY

Techniques for supporting communication on multiple carriers with carrier extension are disclosed herein. A UE may be configured with a base carrier and one or more dependent carriers. A base carrier is a standalone carrier that can support communication on that carrier by itself. A dependent carrier cannot support communication on that carrier by itself and hence may be linked to a base carrier. Control information to support data transmission on a dependent carrier may be sent on an associated base carrier or another standalone carrier.

In one design, a UE may receive a configuration of a base carrier and a dependent carrier for the UE, e.g., via upper-layer signaling. The dependent carrier may be linked to the base carrier. Data transmission on the dependent carrier may be scheduled via a scheduling carrier, which is different from the dependent carrier and may or may not be the base carrier. The UE may receive a scheduling grant on the scheduling carrier. The UE may determine whether the scheduling grant is for the base carrier, or the dependent carrier, or both carriers. The UE may communicate (e.g., send or receive data) on the base carrier and/or the dependent carrier based on the scheduling grant.

In one design, the scheduling grant may comprise a separate grant carrying first scheduling information for the base carrier. In this design, the UE may also receive, on the scheduling carrier, a second scheduling grant comprising a second separate grant carrying second scheduling information for the dependent carrier. The UE may communicate on the base carrier based on scheduling grant and may communicate on the dependent carrier based on the second scheduling grant.

In another design, the scheduling grant may comprise a common grant carrying scheduling information that is common to both the base carrier and the dependent carrier. In yet another design, the scheduling grant may comprise a joint grant carrying first scheduling information for the base carrier and second scheduling information for the dependent carrier. In yet another design, the scheduling grant may be one of a plurality of scheduling grant types. The UE may monitor for scheduling grants of different possible types or of a particular type configured for the UE.

Various aspects and features of the disclosure are described in further detail below.

### BRIEF DESCRIPTION OF THE DRAWINGS

FIG. 1 shows a wireless communication network.

FIG. 2 shows an exemplary frame structure.

FIGS. 3A to 3D show four examples of carrier extension.

FIG. 4 shows an example of data transmission on the downlink and uplink with carrier extension.

FIGS. 5A to 5C show three examples of downlink data transmission with scheduling grants of different types.

FIG. 6 shows an exemplary design of a joint grant.

FIG. 7 shows a process for communicating with carrier extension.

FIG. 8 shows a process for supporting communication with carrier extension.

FIG. 9 shows a block diagram of a design of a base station and a UE.

FIG. 10 shows a block diagram of another design of a base station and a UE.

### DETAILED DESCRIPTION

The techniques described herein may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 includes IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi and Wi-Fi Direct), IEEE 802.16 (WiMAX), IEEE 802.20, Flash-OFDM®, etc. UTRA, E-UTRA, and GSM are part of Universal Mobile Telecommunication System (UMTS). 3GPP Long Term Evolution (LTE) and LTE-Advanced (LTE-A), in both frequency division duplexing (FDD) and time division duplexing (TDD), are recent releases of UMTS that use E-UTRA, which employs OFDMA on the downlink and SC-FDMA on the uplink. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

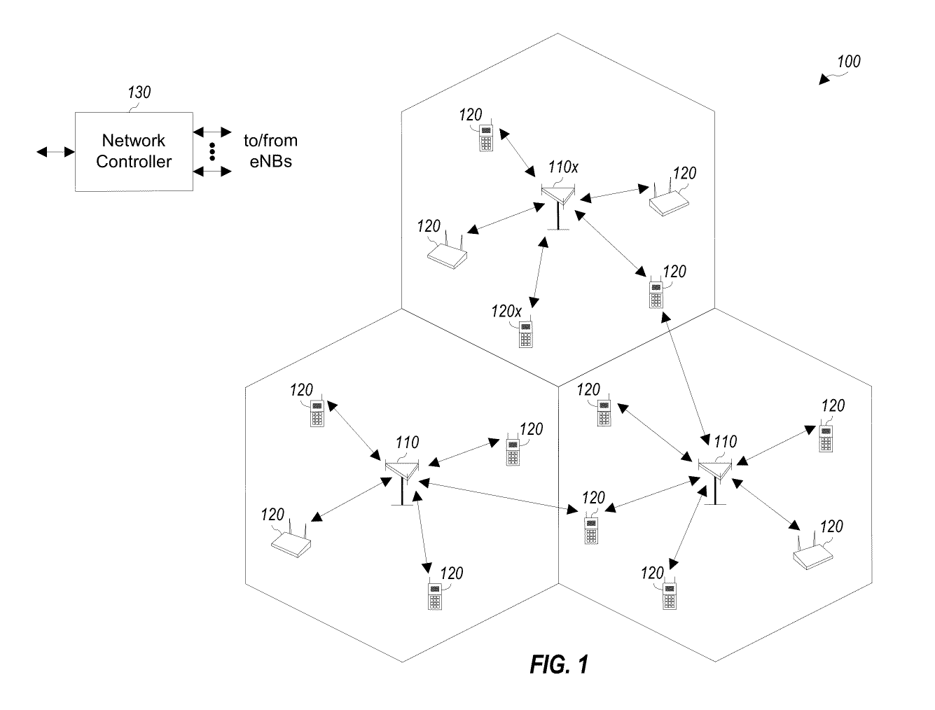

FIG. 1 shows a wireless communication network 100, which may be an LTE network or some other wireless network. Wireless network 100 may include a number of evolved Node Bs (eNBs) 110 and other network entities. An eNB may be an entity that communicates with the UEs and may also be referred to as a Node B, a base station, an access point, etc. Each eNB may provide communication coverage for a particular geographic area and may support communication for the UEs located within the coverage area. To improve network capacity, the overall coverage area of an eNB may be partitioned into multiple (e.g., three) smaller areas. Each smaller area may be served by a respective eNB subsystem. In 3GPP, the term “cell” can refer to a coverage area of an eNB and/or an eNB subsystem serving this coverage area. In general, an eNB may support one or multiple (e.g., three) cells.

A network controller 130 may couple to a set of eNBs and may provide coordination and control for these eNBs. Network controller 130 may communicate with the eNBs via a backhaul. The eNBs may also communicate with one another, e.g., directly or indirectly via wireless or wireline backhaul.

UEs 120 may be dispersed throughout the wireless network, and each UE may be stationary or mobile. A UE may also be referred to as a mobile station, a terminal, an access terminal, a subscriber unit, a station, etc. A UE may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc.

LTE utilizes orthogonal frequency division multiplexing (OFDM) on the downlink and single-carrier frequency division multiplexing (SC-FDM) on the uplink. OFDM and SC-FDM partition a frequency range into multiple (N_{FFT}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FFT}) may be dependent on a carrier bandwidth. For example, the subcarrier spacing may be 15 kilohertz (KHz), and N_{FFT} may be equal to 128, 256, 512, 1024 or 2048 for a carrier bandwidth of 1.4, 3, 5, 10 or 20 megahertz (MHz), respectively.

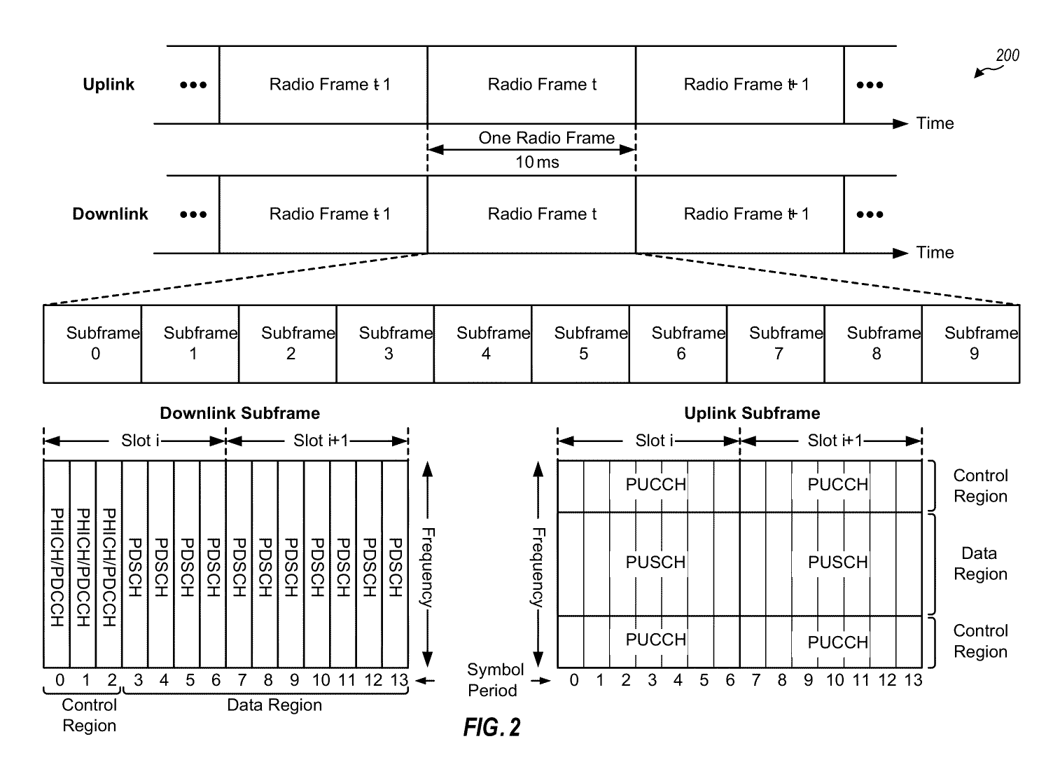

FIG. 2 shows an exemplary frame structure 200 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L−1.

The available time frequency resources for each of the downlink and uplink may be partitioned into resource blocks (RBs). The number of RBs may be dependent on carrier bandwidth and may range from 6 to 110 RBs for carrier bandwidth of 1.4 to 20 MHz, respectively. Each RB may cover 12 subcarriers in one slot and may include a number of resource elements. Each resource element may cover one subcarrier in one symbol period and may be used to send one modulation symbol, which may be a real or complex value.

As shown in FIG. 2, a subframe for the downlink (i.e., a downlink subframe) may include a control region and a data region, which may be time division multiplexed (TDM). The control region may include the first Q symbol periods of the subframe, where Q may be equal to 1, 2, 3 or 4. Q may change from subframe to subframe and may be conveyed in the first symbol period of the subframe. The data region may include the remaining symbol periods of the subframe.

As also shown in FIG. 2, a subframe for the uplink (i.e., an uplink subframe) may include a control region and a data region, which may be frequency division multiplexed (FDM). The control region may include resource blocks near the two edges of the uplink spectrum (as shown in FIG. 2) and may have a configurable size. The data region may include all resource blocks not included in the control region.

In an LTE network, an eNB may transmit a Physical Downlink Control Channel (PDCCH), a Physical HARQ Indicator Channel (PHICH), and/or other physical channels in the control region of a downlink subframe. The PDCCH may carry downlink control information (DCI), which may include as downlink (DL) grants, uplink (UL) grants, transmit power control (TPC) information, etc. The PHICH may carry acknowledgement/negative acknowledgement (ACK/NACK) feedback for data transmissions sent by UEs on the uplink with hybrid automatic retransmission (HARQ). The eNB may also transmit a Physical Downlink Shared Channel (PDSCH) and/or other physical channels in the data region of a downlink subframe. The PDSCH may carry data for UEs scheduled for data transmission on the downlink and/or other information.

A UE may transmit a Physical Uplink Control Channel (PUCCH) in the control region of an uplink subframe or a Physical Uplink Shared Channel (PUSCH) in the data region of the uplink subframe. The PUCCH may carry uplink control information (UCI), which may include ACK/NACK feedback for data transmission on the downlink, channel state information (CSI), scheduling request (SR), etc. The PUSCH may carry only data or both data and UCI. The UE may transmit only the PUCCH or only the PUSCH (but not both) in a subframe in order to maintain a single-carrier waveform, which may have a lower peak-to-average power ratio (PAPR). An uplink transmission may span both slots of a subframe and may hop across frequency.

The various channels in LTE are described in 3GPP TS 36.211, entitled “Evolved Universal Terrestrial Radio Access (E-UTRA); Physical Channels and Modulation,” which is publicly available.

Wireless network 100 may support operation on multiple “standalone” carriers, which may be referred to as carrier aggregation or multi-carrier operation. A standalone carrier is a carrier that can support communication between an eNB and a UE by itself. For example, a standalone carrier for the downlink may support transmission of a primary synchronization signal (PSS), a secondary synchronization signal (SSS), a cell-specific reference signal (CRS), a Physical Broadcast Channel (PBCH), the PDCCH, the PDSCH, and/or other signals and physical channels used to support communication for UEs and enable independent operation on the carrier. A standalone carrier for the uplink may support transmission of the PDCCH, the PUSCH, and/or other signals and physical channels used to support communication for UEs. A standalone carrier may have a bandwidth that is one of the supported bandwidths, e.g., a bandwidth of 1.4, 3, 5, 10, 15 or 20 MHz in LTE.

Wireless network 100 may also support operation on “dependent” carriers on the downlink and/or uplink, which may be referred to as carrier extension. A dependent carrier is a carrier that cannot support communication between an eNB and a UE without involving another carrier. For example, a dependent carrier for the downlink may not support transmission of PSS, SSS, PDCCH, etc. A dependent carrier for the uplink may not support transmission of PUCCH, etc. A dependent carrier may not support transmission of control information or may support transmission of only a subset of the control information needed to support communication on that carrier. A dependent carrier may have a bandwidth that is smaller than the smallest supported bandwidth, e.g., a bandwidth of less than 1.4 MHz in an LTE network. A dependent carrier may also be referred to as a non-standalone carrier, an extension carrier, a carrier segment, etc.

In an exemplary design, a dependent carrier may be linked to (i.e., associated with) a standalone carrier to support communication on the dependent carrier. A standalone carrier linked to a dependent carrier may be referred to as a base carrier. In general, any number of dependent carriers may be linked to a given base carrier. Furthermore, a dependent carrier may or may not be contiguous in frequency with its linked base carrier. A dependent carrier and its linked base carrier may be served by a single base station. Alternatively, a dependent carrier may be served by one base station and its linked base carrier may be served by another base station. The two base stations may be co-located at the same site or may be located at different sites.

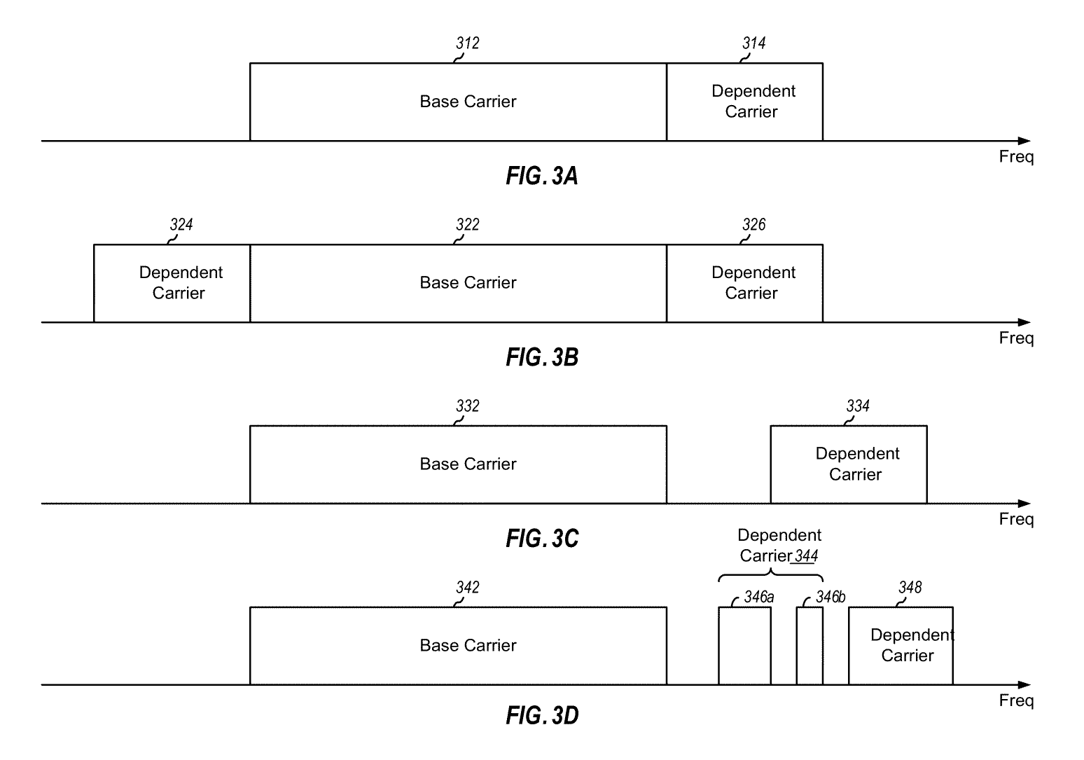

FIG. 3A shows a first example of carrier extension. In this example, a single dependent carrier 314 is linked to a base carrier 312 and is contiguous with base carrier 312.

FIG. 3B shows a second example of carrier extension. In this example, two dependent carriers 324 and 326 are linked to a base carrier 322 and are contiguous with base carrier 322. Dependent carrier 324 is lower in frequency than base carrier 322, and dependent carrier 326 is higher in frequency than base station 322. Dependent carriers 324 and 326 may also be considered as a single dependent carrier.

FIG. 3C shows a third example of carrier extension. In this example, a single dependent carrier 334 is linked to a base carrier 332 and is not contiguous with base carrier 332.

FIG. 3D shows a fourth example of carrier extension. In this example, two dependent carriers 344 and 348 are linked to a base carrier 342 and are not contiguous with base carrier 342. Dependent carrier 344 includes two non-contiguous frequency segments 346a and 346b. Frequency segments 346a and 346b may also be considered as two dependent carriers. Alternatively, dependent carriers 344 and 348 may be considered as a single dependent carrier.

As shown in FIGS. 3A to 3D, a dependent carrier may be located anywhere in frequency relative to its linked base carrier. Furthermore, a dependent carrier may comprise a single frequency segment of contiguous bandwidth or multiple frequency segments that are not contiguous with each other. Each frequency segment may correspond to a continuous range of frequencies that may be too small to operate as a standalone carrier. For example, a frequency segment may correspond to a 200 KHz frequency channel in GSM, which is smaller than the smallest bandwidth of 1.4 MHz supported by LTE. A frequency segment formed by one 200 KHz frequency channel in GSM may include one resource block (RB) and may cover 180 KHz. In general, dependent carriers may be formed with frequency channels “harvested” from wireless networks utilizing older radio access technologies (e.g., GSM) and/or with frequency spectrum not sufficient to form standalone carriers.

A frequency segment of a dependent carrier may have a bandwidth that is an integer multiple of one RB, with a RB having a bandwidth of 180 KHz and covering 12 subcarriers in LTE. The bandwidth of a frequency segment may have a granularity of one RB. In one exemplary design, the bandwidth of a frequency segment may be within a range of one to six RBs, or 180 KHz to 1.08 MHz. Other bandwidth ranges and/or bandwidth granularities may also be supported for a frequency segment.

Dependent carriers may be defined on a per-UE basis. For example, three frequency segments may be available as shown in FIG. 3D. Two dependent carriers 344 and 348 may be defined for a first UE. A single dependent carrier comprising all three frequency segments in FIG. 3D may be defined for a second UE. Three dependent carriers each comprising one frequency segment may also be defined for a third UE. The dependent carrier(s) defined for each UE may be signaled to that UE, e.g., via upper layer signaling such as Radio Resource Control (RRC) signaling.

Dependent carriers may also be defined for a group of UEs and may be signaled to all UEs in the group. Dependent carriers may also be defined for all UEs served by an eNB or a cell. These dependent carriers may be signaled to UEs via a broadcast channel, system information, unicast signaling, etc.

A linkage/association between one or more dependent carriers and a base carrier may be performed on a per-UE basis, e.g., via upper layer (e.g., RRC) signaling. Different UEs may have different configurations of dependent carriers. For example, different UEs may be assigned different combinations of base carriers and dependent carriers and may thus have different linkage/association of dependent carriers to base carriers. Configuration of dependent carriers for a given UE may be dependent on various factors such as availability of dependent carriers, data requirements and/or other attributes of the UE, network loading, etc.

A UE may communicate with multiple cells for carrier aggregation. One cell may be designated as a primary cell (Pcell) for the UE, and each remaining cell may be considered as a secondary cell (Scell) for the UE. DCI, UCI and data may be sent on the primary cell, whereas data and possibly some control information may be sent on a secondary cell. The primary cell and secondary cell(s) may be referred to as serving cells. The primary cell may be associated with a DL standalone carrier and an UL standalone carrier, which may be referred to as a DL primary component carrier (PCC) and an UL PCC, respectively. Each secondary cell may be associated with a DL standalone carrier and/or an UL standalone carrier, each of which may be referred to as a secondary component carrier (SCC).

A dependent carrier may be considered as an extension of a serving cell of a UE and may be linked to the primary cell or a secondary cell. It may be desirable to link a dependent carrier to a secondary cell, e.g., if the dependent carrier and a carrier for the secondary cell are on the same band whereas a carrier for the primary cell is on a different band. Linking a DL dependent carrier to a DL base carrier (for the primary cell or a secondary cell) may be useful for CSI reporting and for scheduling without using a cross-carrier indicator field (CIF). Linking an UL dependent carrier to an UL base carrier (for the primary cell or a secondary cell) may be useful for pathloss estimation and for scheduling without using CIF.

DL and UL dependent carriers may be configured independently. A UE may be configured with one or more DL dependent carriers, or one or more UL dependent carriers, or both DL and UL dependent carriers. An UL dependent carrier may be linked with a serving cell having no UL standalone carrier. In this case, separate UL grants may be sent to schedule UL data transmission on the UL base carrier and the UL dependent carrier associated with different cells.

A dependent carrier may be configured or deconfigured for a UE. A configured dependent carrier may be either activated for use or deactivated. A deconfigured dependent carrier may not be available for use. In one design, a dependent carrier may be activated or deactivated based on the same activation/deactivation command used for a serving cell to which the dependent carrier is linked. In this design, a dependent carrier is not activated or deactivated separately from a linked base carrier for the linked serving cell. Alternatively, a dependent carrier may be activated or deactivated independently of the linked serving cell.

In one aspect of the present disclosure, control information to support data transmission on a dependent carrier may be sent on a linked base carrier or another standalone carrier. This may allow the dependent carrier to include only the data region and no control region, which may reduce overhead. For simplicity, much of the description below assumes a case in which (i) a single dependent carrier is linked to a base carrier for each of the downlink and uplink and (ii) the base carrier for each link is a primary carrier for that link. However, the present disclosure is not limited to particular carrier configuration.

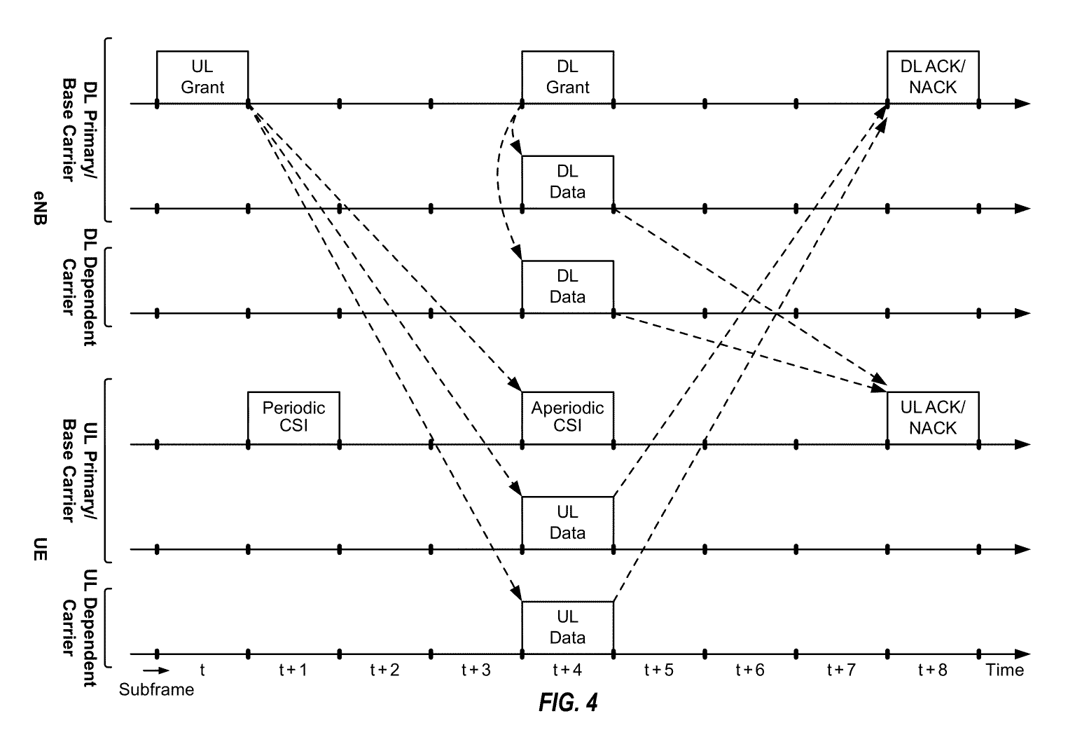

FIG. 4 shows an example of data transmissions on the downlink and uplink with carrier extension. In the example shown in FIG. 4, a UE is configured with a DL standalone/base carrier, a DL dependent carrier, an UL standalone/base carrier, and an UL dependent carrier for communication with an eNB.

The UE may be configured to periodically report CSI to the eNB. The UE may then periodically estimate a wireless channel for the eNB and may determine CSI for the DL base carrier and possibly the DL dependent carrier. The CSI may include channel quality indicator (CQI), precoding matrix indicator (PMI), rank indicator (RI), etc. RI may indicate the number of layers or spatial channels to use for data transmission. PMI may indicate a precoding matrix or vector to use for precoding data prior to transmission. CQI may indicate a channel quality for each transport block. The UE may periodically send CSI to the eNB and/or may send CSI when requested by the eNB.

For UL data transmission, the eNB may send an UL grant on the DL primary/base carrier in subframe t to schedule the UE for data transmission on the uplink. An UL grant is a scheduling grant to schedule data transmission on the uplink. The UL grant may include various parameters for generating and transmitting data on the UL base carrier and/or the UL dependent carrier. The UL grant may also include a CSI request. The UE may receive the UL grant, process (e.g., encode and modulate) UL data based on the UL grant, and transmit the UL data on the UL base carrier and/or the UL dependent carrier in subframe t+4. The eNB may receive and process the UL data from the UE, determine whether the UL data was decoded correctly or in error, determine ACK/NACK for the UL data, and send the ACK/NACK on the DL primary carrier in subframe t+8. ACK/NACK sent on the downlink for data transmission on the uplink may be referred to as DL ACK/NACK.

For DL data transmission, the eNB may send a DL grant on the DL primary/base carrier in subframe t+4 to schedule the UE for data transmission on the downlink. A DL grant is a scheduling grant to schedule data transmission on the downlink. The eNB may also transmit DL data on the DL base carrier and/or the DL dependent carrier in subframe t+4 to the UE. The DL grant may include various parameters for receiving and decoding the DL data sent to the UE. The UE may receive the DL grant on the DL base carrier and the DL data on the DL base carrier and/or the DL dependent carrier. The UE may process (e.g., demodulate and decode) the DL data based on the DL grant, determine whether the DL data was decoded correctly or in error, determine ACK/NACK for the DL data, and send the ACK/NACK on the UL primary/base carrier in subframe t+8. ACK/NACK sent on the uplink for data transmission on the downlink may be referred to as UL ACK/NACK.

As shown in FIG. 4, the eNB may send DCI such as scheduling grants on the PDCCH, DL ACK/NACK on the PHICH, and data on the PDSCH. The UE may send UCI such as UL ACK/NACK, CSI, scheduling request (SR), etc. The UE may send UCI on the PUCCH when the UE is not scheduled for uplink data transmission and may send UCI with data on the PUSCH when the UE is scheduled for uplink data transmission.

As shown in FIG. 4, a scheduling grant for a given link (either DL or UL) may be sent on a DL primary carrier to schedule data transmission on a base carrier and/or a dependent carrier. In general, any standalone carrier may schedule a dependent carrier and may be referred to as a scheduling carrier. The scheduling carrier may be the DL primary carrier or some other standalone carrier. For clarity, much of the description below assumes that the DL primary carrier is the scheduling carrier. The scheduling grant may include various parameters such as a modulation and coding scheme (MCS), a redundancy version (RV) and an HARQ process number for HARQ, a resource allocation, etc.

Table 1 lists four different types of scheduling grants that may be supported for carrier extension. In general, any one or any combination of the scheduling grant types in Table 1 may be supported. Other types of scheduling grants may also be supported for carrier extension.

TABLE 1
Scheduling Grants for Carrier Extension

| Scheduling | |
|---|---|
| Grant | Description |
| Separate Grant | Scheduling grant including scheduling |
| | information for only a base |
| | carrier or a dependent carrier. |
| Common Grant | Scheduling grant including scheduling |
| | information common to both |
| | a base carrier and a dependent carrier. |
| Joint Grant | Scheduling grant including separate |
| | scheduling information for a |
| | base carrier and a dependent carrier. |
| Combination | Scheduling grant including scheduling |
| Grant | information for only a base carrier, |
| | or only a dependent carrier, or both the base |
| | carrier and the dependent carrier. |

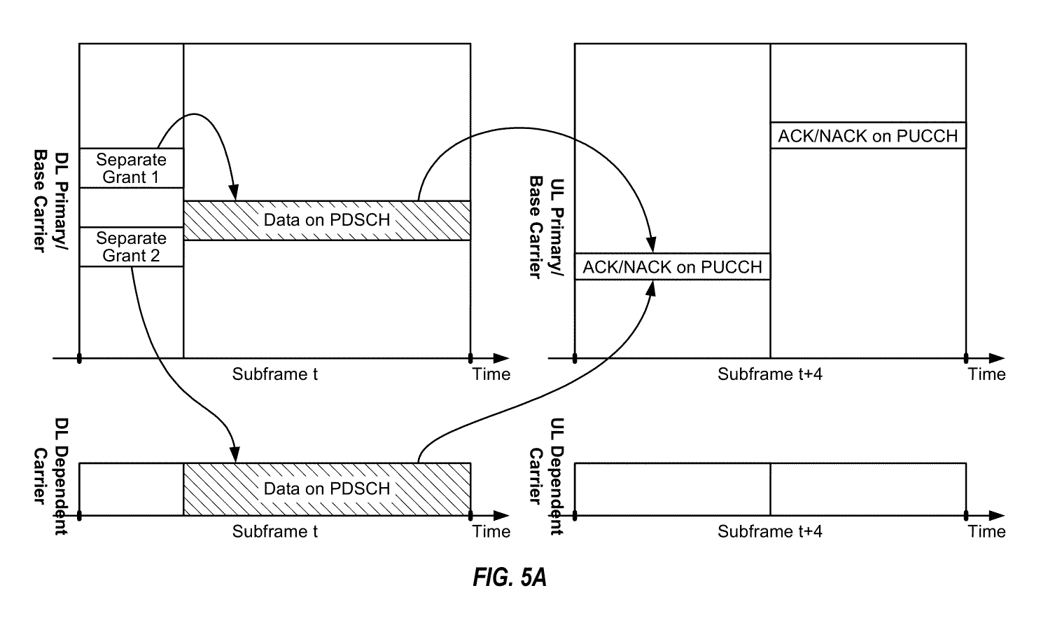

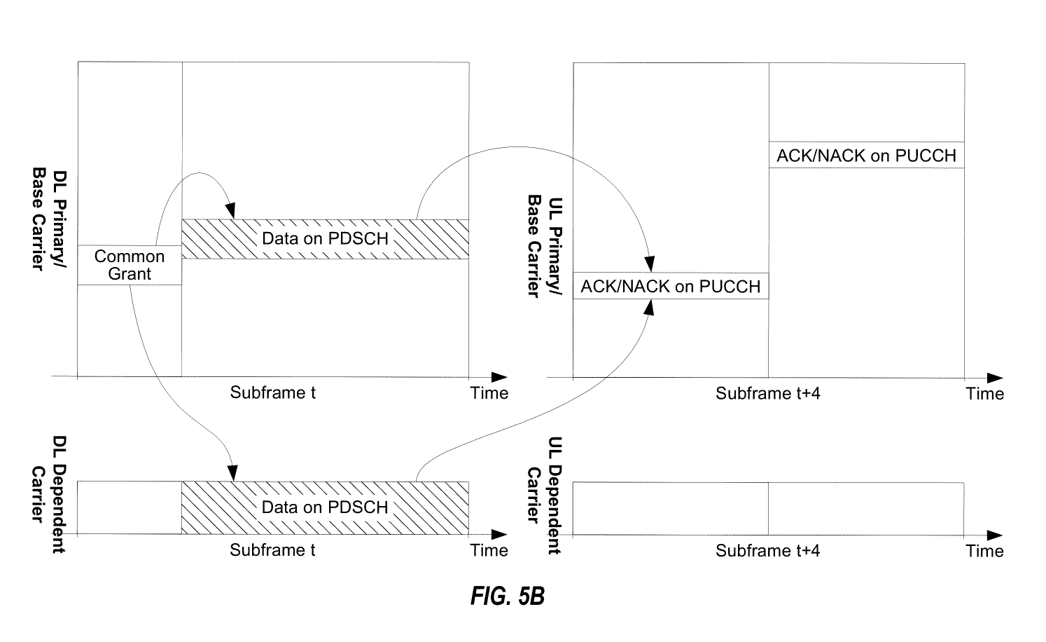

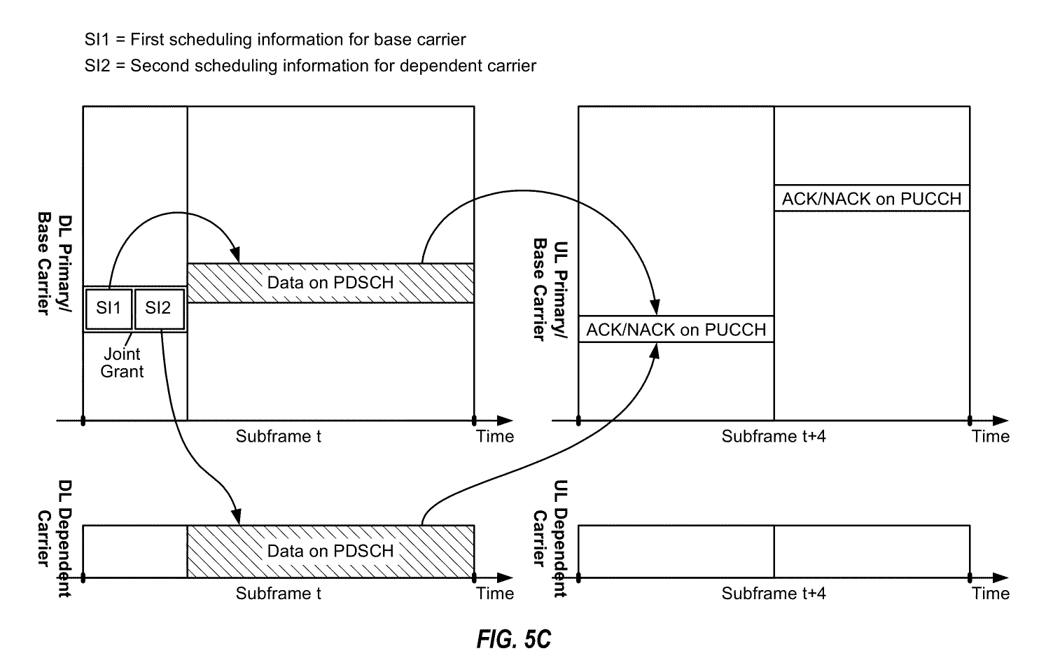

FIG. 5A shows an example of DL data transmission with separate grants. An eNB may send first and second DL grants on a DL primary/base carrier to a UE. Each DL grant may be sent as a separate DCI/message on the PDCCH and may be separately received and decoded by the UE. The first DL grant may include first scheduling information for a first DL data transmission on the DL base carrier. The second DL grant may include second scheduling information for a second DL data transmission on the DL dependent carrier. The eNB may send (i) the first DL data transmission on the PDSCH on the DL base carrier and (ii) the second DL data transmission on the PDSCH on the DL dependent carrier. The UE may receive the two DL grants on the DL base carrier. The UE may receive and process the first DL data transmission on the DL base carrier in accordance with the first DL grant. The UE may receive and process the second DL data transmission on the DL dependent carrier in accordance with the second DL grant. The UE may send ACK/NACK for both DL data transmissions on the UL base carrier. The ACK/NACK for the two DL data transmissions may be sent separately or jointly on the PUCCH or the PUSCH.

FIG. 5A shows DL data transmissions on DL carriers with separate DL grants. UL data transmissions on UL carriers with separate UL grants may be supported in similar manner.

A separate grant may include parameters (e.g., an MCS and a redundancy version) for data transmission on a single carrier. Separate grants may provide flexibility in scheduling data transmissions on a base carrier and a dependent carrier. Separate grants may allow data transmission to be sent on each carrier based on conditions applicable to that carrier. For example, separate grants may provide good link adaptation for the base carrier and also for the dependent carrier, especially when the base carrier and the dependent carrier are in different bands and/or are served by non co-located base stations. Separate grants may also be readily supported by using existing mechanisms for sending and receiving scheduling grants for one carrier.

FIG. 5B shows an example of DL data transmission with a common grant. An eNB may send a DL common grant on a DL primary/base carrier to a UE. The DL common grant may include scheduling information common to both a first DL data transmission on the DL base carrier and a second DL data transmission on the DL dependent carrier. For example, the DL common grant may include an MCS, a redundancy version, and/or other parameters that are applicable for both DL data transmissions on the DL base carrier and the DL dependent carrier. The UE may receive the DL common grant. The UE may also receive and process the first DL data transmission on the DL base carrier in accordance with the DL common grant. The UE may also receive and process the second DL data transmission on the DL dependent carrier in accordance with the DL common grant. The UE may send ACK/NACK for both DL data transmissions on the UL primary/base carrier.

FIG. 5B shows DL data transmissions on DL carriers with a DL common grant. UL data transmissions on UL carriers with an UL common grant may be supported in similar manner.

A common grant may include common parameters (e.g., an MCS and a redundancy version) for data transmissions on a base carrier and a dependent carrier. The common parameters may reduce signaling overhead and provide good performance when the base carrier and the dependent carrier observe similar channel conditions, which may often be the case when these carriers are in the same band and are served by the same base station or two co-located base stations. The common parameters may be defined to address differences between scheduling a single carrier and scheduling multiple carriers. For example, a common parameter for allocated resources on the base carrier and the dependent carrier may be defined to account for a combined/composite bandwidth of both carriers being larger than 20 MHz and covering more than 110 RBs. The common parameters may also account for different transmission modes being used for the base carrier and the dependent carrier, e.g., a multiple-input multiple-output (MIMO) transmission mode used for the base carrier and a non-MIMO transmission mode (e.g., a single-input multiple-output (SIMO) mode) used for the dependent carrier.

FIG. 5C shows an example of DL data transmission with a joint grant. An eNB may send a DL joint grant on a DL primary/base carrier to a UE. The DL joint grant may include (i) first scheduling information for a first DL data transmission on the DL base carrier and (ii) second scheduling information for a second DL data transmission on the DL dependent carrier. The scheduling information for each carrier may include an MCS, a redundancy version, and/or other parameters that may be applicable for data transmission on that carrier. The UE may receive the DL joint grant on the DL base carrier. The UE may receive and process the first DL data transmission on the DL base carrier in accordance with the first scheduling information. The UE may also receive and process the second DL data transmission on the DL dependent carrier in accordance with the second scheduling information. The UE may send ACK/NACK for both DL data transmissions on the UL base carrier.

FIG. 5C shows DL data transmissions on DL carriers with a DL joint grant. UL data transmissions on UL carriers with an UL joint grant may be supported in similar manner.

A joint grant may include separate scheduling information for data transmissions on a base carrier and a dependent carrier. A joint grant may be defined in various manners using various message formats.

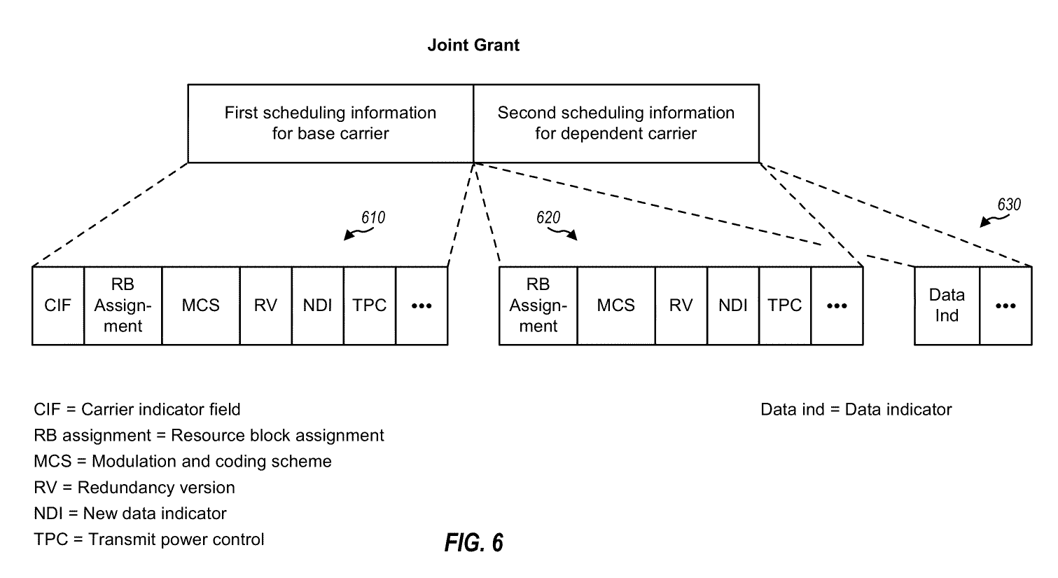

FIG. 6 shows an exemplary design of a joint grant for a base carrier and a dependent carrier. The joint grant may include first scheduling information for the base carrier and second scheduling information for the dependent carrier. The first scheduling information may include various parameters 610 for data transmission on the base carrier. For example, the first scheduling information may include one or more parameters/fields in Table 2. Parameters that may be included in a scheduling grant in LTE are described in 3GPP 36.212, which is publicly available.

TABLE 2
Parameters/Fields for Scheduling Information

| Parameter/Field | Description |
|---|---|
| Carrier indicator | Indicate a carrier for which scheduling information |
| field (CIF) | applies. |
| Resource block | Indicate RBs assigned for data transmission. |
| (RB) assignment | |
| Modulation & | Indicate modulation and coding scheme of transport |
| coding scheme | block being sent. |
| (MCS) | |
| Redundancy | Indicate redundancy version of transport block being |
| version (RV) | sent. |
| New data | Indicate whether a new transport block is being sent |
| indicator (NDI) | |
| Transmit power | Indicate adjustment to transmit power of UE on uplink. |
| control (TPC) | |

In one design, the second scheduling information for the dependent carrier may be dependent on whether separate HARQ or common HARQ is used for the base carrier and the dependent carrier. Separate HARQ refers to transmission of different data (e.g., different transport blocks) on the base carrier and the dependent carrier. For example, two transport blocks may be processed to generate two codewords, one codeword may be sent on the base carrier, and the other codeword may be sent on the dependent carrier. Common HARQ refers to transmission of data across carriers. For example, one transport block may be processed to generate one codeword, a first part of the codeword may be sent on the base carrier, and a second part of the codeword may be sent on the dependent carrier.

For separate HARQ, the second scheduling information for the dependent carrier may include various parameters 620 such as RB assignment, MCS, RV, NDI, TPC, etc. for data transmission on the dependent carrier. The RB assignment may be omitted if the entire dependent carrier is assigned or may be given with few bits if the dependent carrier includes fewer RBs and/or the RBs of the dependent carrier are assigned with coarse granularity. The MCS for the dependent carrier may be an absolute value (e.g., determined based on channel conditions of the dependent carrier) or a relative value (e.g., relative to the MCS for the base carrier). Separate MCSs for the base carrier and the dependent carrier may enable independent link adaptation for the two carriers, which may improve performance, especially if the two carriers are in different bands and/or are served by non co-located base stations. A non-MIMO transmission mode may be used for the dependent carrier.

For common HARQ, the second scheduling information for the dependent carrier may include one or more parameters 630 such as a data indicator (Ind) to convey whether or not the dependent carrier is scheduled for data transmission. Parameters such as MCS, RV, and NDI from the first scheduling information may be for the data transmission on the dependent carrier, which may reduce signaling overhead for the dependent carrier. Link adaptation for the dependent carrier may be performed in similar manner as for the base carrier. Since data is transmitted across both carriers, single ACK/NACK feedback may be sent for both carriers.

FIG. 6 shows an exemplary design of a joint grant for a case in which one dependent carrier is linked to a base carrier. In this case, a joint grant may include one set of parameters 620 or 630 for the dependent carrier. Furthermore, linkage of the dependent carrier to the base carrier may be configured via upper-layer signaling (e.g., RRC) and may be known a priori. In this case, a joint grant does not need to include a CIF to identify the dependent carrier. If multiple dependent carriers can be linked to a base carrier, then a joint grant may include one set of parameters 620 or 630 for each dependent carrier being scheduled. Furthermore, each set of parameters may include a CIF to identify a dependent carrier for which that set of parameters applies.

Different transmission modes may be supported for the base carrier and the dependent carrier. For example, a MIMO transmission mode may be supported for the base carrier, and a non-MIMO transmission mode may be supported for the dependent carrier. Alternatively, the same transmission mode may be supported for the base carrier and the dependent carrier. For example, a MIMO transmission mode or a non-MIMO mode may be supported for both carriers.

A joint grant may be used to schedule data transmission on only the base carrier or on both the base carrier and the dependent carrier, as described above. A joint grant may also be used to schedule data transmission on only the base carrier, or only the dependent carrier, or both the base carrier and the dependent carrier. A joint grant may include a data indicator parameter/field that may indicate whether or not the dependent carrier is being scheduled, e.g., as shown in FIG. 6. A joint grant may also include a parameter/field to indicate whether or not the base carrier is scheduled. Alternatively, a joint grant may indicate that the base carrier is not scheduled by setting the RB assignment (or some other parameter/field) to a zero value or an invalid value for that parameter/field. In either case, when only the dependent carrier is scheduled, the parameters for the first scheduling information may be for the dependent carrier.

In one design, one type of scheduling grant may be used to schedule a base carrier and/or a linked dependent carrier. For example, the base carrier and/or the dependent carrier may be scheduled via only separate grants, or only common grants, or only joint grants. A UE may know to monitor for scheduling grants of a specific type when configured for carrier extension.

In another design, different types of scheduling grant may be used to schedule a base carrier and/or a dependent carrier. For example, the base carrier and/or the dependent carrier may be scheduled via separate grants some of the time and via common grants and/or joint grants some other time. Different types of scheduling grants may be used depending on various factors such as the bandwidth of the dependent carrier, whether the base carrier and the dependent carrier are in the same band, whether the two carriers are served by co-located base stations, etc. A UE may detect for scheduling grants of one or more types when configured for carrier extension.

A combination grant may be used to schedule data transmission on only a base carrier, or only a dependent carrier, or both the base carrier and the dependent carrier. A combination grant may comprise (i) a separate grant for only one carrier or (ii) a common grant or a joint grant for both carriers. In one design, whether a combination grant applies to only one carrier or both carriers may be dynamically changed. In this design, the UE may monitor for up to two scheduling grants for a given link in a give subframe. In particular, the UE may expect (i) only one scheduling grant for only the base carrier, or only the dependent carrier, or both the base carrier and the dependent carrier or (ii) two scheduling grants—one scheduling grant for the base carrier and another scheduling grant for the dependent carrier. The UE may perform blind decoding to detect for one or two scheduling grants in a subframe. Alternatively, the CIF or another field in a combination grant may indicate whether the combination grant applies to the base carrier and/or the dependent carrier.

In another design, whether a combination grant applies to only one carrier or both carriers may be semi-statically configured. For example, a semi-static configuration may indicate that a combination grant comprises (i) a separate grant to assign resources separately for the base carrier or the dependent carrier or (ii) a common grant or a joint grant to assign resources for both carriers.

In one design, combination grants may be semi-statically configured for a UE by upper-layer signaling (e.g., RRC) according to one of the following types:
1. Separate grant type for the base carrier and the dependent carrier, or
2. Joint/common grant type for the base carrier and the dependent carrier.

Separate grants may be used for the base carrier and the dependent carrier in various scenarios such as (i) when the dependent carrier has a medium to large size (e.g., 6 to 15 RBs), which may justify a larger overhead for a separate grant for the dependent carrier, and/or (ii) when the base carrier and the dependent carrier are in different bands and/or are served by non co-located base stations, which may benefit from independent link adaptation for the two carriers via two separate grants. Each carrier may be assigned a unique carrier index, e.g., via RRC. A separate grant may include a CIF carrying a carrier index of a carrier to which the separate grant applies.

A joint grant may be used for both the base carrier and the dependent carrier in various scenarios such as (i) when the dependent carrier has a small size (e.g., 1 to 5 RBs), which may not justify a larger overhead for a separate grant for the dependent carrier, and/or (ii) when the base carrier and the dependent carrier are in the same band and are served by one base station or two co-located base stations. The joint grant may avoid additional blind decoding by a UE to monitor for separate grants for two carriers. The joint grant may also avoid using additional resources to send separate grants for the dependent carrier

Combination grants may provide flexibility in scheduling the base carrier and the dependent carrier by allowing for use of separate grants or common/joint grants depending on operating scenario. Semi-static configuration of combination grants may provide sufficient flexibility while simplifying operation. Dynamic selection of combination grants may provide more flexibility with some additional overhead.

Referring back to FIG. 4, an eNB may send DL ACK/NACK on a DL primary/base carrier for an UL data transmission received from a UE on an UL base carrier and/or an UL dependent carrier. In one design, the eNB may send the DL ACK/NACK on the PHICH on the same DL primary/base carrier on which an UL grant was sent for the DL data transmission. If common HARQ is used for both the UL base carrier and the UL dependent carrier, then the eNB may send a single DL ACK/NACK for both UL carriers. Alternatively, if separate HARQ is used for the two UL carriers, then the eNB may send separate DL ACK/NACK for the two UL carriers. The eNB may send DL ACK/NACK for the UL dependent carrier in different manners depending on the type of scheduling grant used to schedule the two UL carriers. If separate grants are used for the two UL carriers, then the UL dependent carrier may be considered as an UL SCC, and DL ACK/NACK for the UL dependent carrier may be sent in similar manner as DL ACK/NACK for an UL SCC. If a common grant or a joint grant is used for the two UL carriers, then DL ACK/NACK for the two UL carriers may be sent as described in LTE Release 10, e.g., on ACK resources determined based on a first control channel element (CCE) of the PDCCH used to send the common grant or joint grant. However, RBs of the UL dependent carrier may be numbered with an offset with respect to the RBs of the UL base carrier in order to avoid possible collision. Furthermore, a separate demodulation reference signal (DM-RS) field may be included for the UL dependent carrier in the common grant or joint grant.

As shown FIG. 4, a UE may send UL ACK/NACK on an UL primary/base carrier for a DL data transmission received from an eNB on a DL base carrier and/or a DL dependent carrier. The UE may send the UL ACK/NACK on the PUCCH or the PUSCH on the UL base carrier. If common HARQ is used for both the DL base carrier and the DL dependent carrier, then the UE may send a single UL ACK/NACK for both DL carriers. Alternatively, if separate HARQ is used for the two DL carriers, then the UE may send separate UL ACK/NACK for the two DL carriers. The UE may send UL ACK/NACK for the DL dependent carrier in different manners depending on the type of scheduling grant used to schedule the two DL carriers. If separate grants are used for the two DL carriers, then the DL dependent carrier may be considered as a DL SCC, and UL ACK/NACK for the DL dependent carrier may be sent in similar manner as UL ACK/NACK for a DL SCC. For example, UL ACK/NACK for the DL dependent carrier may be sent using PUCCH format 1b with channel selection or PUCCH format 3. If a common grant or a joint grant is used for the two DL carriers, then UL ACK/NACK for the two DL carriers may be sent on (i) ACK/NACK resources configured for the UE, e.g., via upper-layer signaling, or (ii) ACK/NACK resources implicitly determined based on the scheduling grant.

As shown in FIG. 4, a UE may send CSI upon receiving a request from an eNB, which may be referred to as aperiodic CSI. In one design, a DL dependent carrier may be considered as a DL SCC, and a CSI request may be sent in a DL grant to request reporting of CSI for the DL dependent carrier.

A UE may also send CSI periodically, which may be referred to as periodic CSI. In one design, the UE may separately send periodic CSI for the DL base carrier and the DL dependent carrier. Periodic CSI reporting may be independently configured for each DL carrier. The UE may send periodic CSI for each DL carrier based on a CSI reporting configuration for that DL carrier. The UE may send a periodic CSI report for only one DL carrier in a given subframe. If periodic CSI reports for both DL carriers are due in the same subframe, then the UE may select one DL carrier for CSI reporting based on the priorities of all DL carriers.

The priorities of the DL carriers may be defined based on the type of CSI report to send for each DL carrier, the indices of the DL carriers, etc. For example, a DL carrier with RI to report may have higher priority than a DL carrier with CQI to report. If the same type of CSI is to be reported for both DL carriers, then a DL carrier with a lower index may have higher priority than a DL carrier with a higher index. The DL base carrier may be assigned a lower index (and hence may have a higher priority) than the DL dependent carrier. In one design, only wideband CSI may be reported for the DL dependent carrier whereas subband CSI or wideband CSI may be reported for the DL base carrier. Wideband CSI may refer to CSI obtained based on measurements across the entire carrier bandwidth. Subband CSI may refer to CSI obtained based on measurements for a particular subband of the carrier bandwidth. Wideband CSI may be sufficient for the DL dependent carrier due to its smaller bandwidth and may also reduce signaling overhead for periodic CSI reporting.

In another design, the UE may jointly send periodic CSI for the DL base carrier and the DL dependent carrier in the same subframe. The UE may send a single CSI report comprising CSI for both DL carriers (e.g., for the combined bandwidth of both DL carriers), which may be especially applicable for a common grant for the two DL carriers. Alternatively, the UE may send a CSI report including CSI for the DL base carrier as well as CSI for the DL dependent carrier, which may be especially applicable for a joint grant for the two DL carriers. The CSI for the DL dependent carrier may be given with absolute values (absolute CSI) or may be relative to the CSI for the DL base carrier (delta CSI). The CSI report containing CSIs for the two DL carriers may be sent using PUCCH format 3 having a larger payload.

A UE may transmit a sounding reference signal (SRS) on the uplink to enable an eNB to estimate the uplink channel from the UE to the eNB. In one design, the UE may periodically transmit SRS for both an UL base carrier and an UL dependent carrier based on a common SRS configuration that is applicable for both UL carriers. For example, the SRS configuration may indicate a periodicity of SRS transmission, specific subframes in which to transmit SRS, a bandwidth over which to transmit SRS, etc.

In another design, the UE may transmit SRS on each UL carrier based on a separate SRS configuration for that UL carrier. In this design, SRS transmission may be independently configured for each UL carrier. The SRS configuration for the UL dependent carrier may be simplified relative to the SRS configuration for the UL base carrier. For example, the SRS configuration for the UL dependent carrier may indicate only an SRS periodicity (which determines how often to transmit SRS) and an offset (which determines the specific subframes in which to transmit the SRS). SRS may be transmitted across the entire bandwidth of the UL dependent carrier, which may be acceptable due to the small bandwidth of the UL dependent carrier.

The UE may also transmit SRS whenever requested by the eNB, which may be referred to as aperiodic SRS. The eNB may send an SRS request in an UL grant. If separate grants are used for the UL base carrier and the UL dependent carrier, then aperiodic SRS may be requested independent for the two UL carriers. If a common grant or a joint grant is used for the two UL carriers, then aperiodic SRS may be requested for only the UL base carrier or both the UL base carrier and the UL dependent carrier via the common grant or joint grant. For all cases, aperiodic SRS may be transmitted based on parameters configured via upper-layer (e.g., RRC) signaling.

Power control may be performed to adjust the transmit power of a UE for transmission on the uplink. In one design, power control may be performed jointly for the UL base carrier and the UL dependent carrier. In this design, an eNB may estimate the pathloss of (or received signal quality of an uplink transmission on) the UL base carrier and/or the UL dependent carrier and may generate a TPC command based on the estimated pathloss. The eNB may send the TPC command to the UE, which may adjust the transmit power of both UL carriers based on the TPC command. In another design, power control may be performed separately for the UL base carrier and the UL dependent carrier. In this design, the eNB may estimate the pathloss of an uplink transmission on each UL carrier and may generate a TPC command for that UL carrier. The UE may adjust the transmit power of each UL carrier based on the TPC command received from the eNB for that UL carrier. The eNB may estimate pathloss for the UL dependent carrier based on (i) the DL base carrier linked to the UL dependent carrier and/or (ii) the DL dependent carrier linked to the same base carrier, which may be determined based on RRC configuration and may be dependent on implementation scenario.

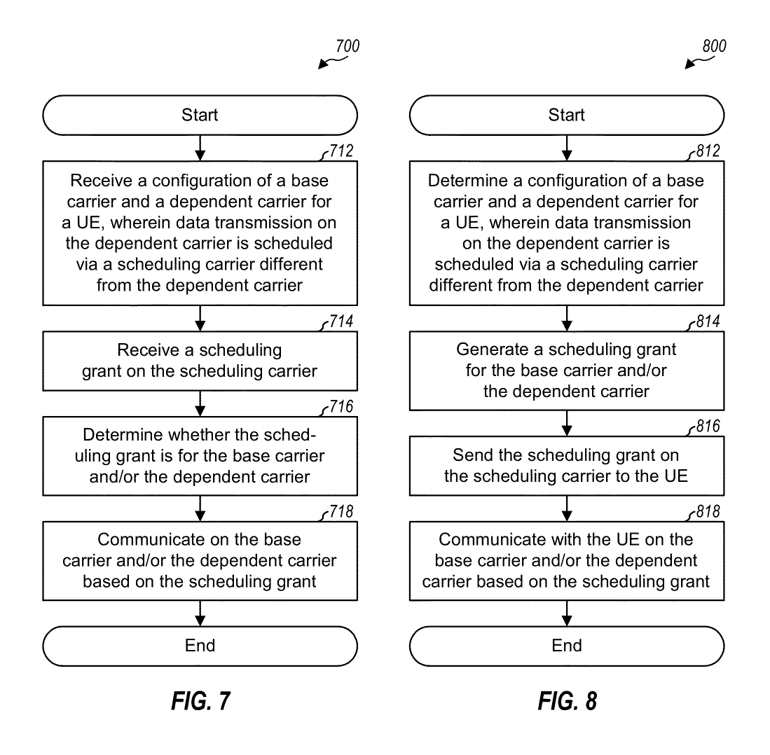

FIG. 7 shows a design of a process 700 for communicating with carrier extension. Process 700 may be performed by a UE (as described below) or by some other entity. The UE may receive a configuration of a base carrier and a dependent carrier for the UE, e.g., via upper-layer signaling (block 712). The dependent carrier may be linked to the base carrier. Data transmission on the dependent carrier may be scheduled via a scheduling carrier, which is different from the dependent carrier. The scheduling carrier may be a carrier designated to carry scheduling grants for the base carrier and the dependent carrier. The scheduling carrier may be the base carrier, or a DL primary carrier for the UE, or some other carrier. The UE may receive a scheduling grant on the scheduling carrier (block 714). The UE may determine whether the scheduling grant is for the base carrier, or the dependent carrier, or both the base carrier and the dependent carrier (block 716). The UE may communicate (e.g., send or receive data) on the base carrier and/or the dependent carrier based on the scheduling grant (block 718).

In one design, the base carrier and the dependent carrier may be for uplink communication, and the scheduling grant may schedule uplink data transmission on the base carrier and/or the dependent carrier. In another design, the base carrier and the dependent carrier may be for downlink communication, and the scheduling grant may schedule downlink data transmission on the base carrier and/or the dependent carrier. The UE may receive a second configuration of a second base carrier and a second dependent carrier for the uplink for the UE. Downlink data transmission on the dependent carrier and uplink data transmission on the second dependent carrier may be scheduled via the scheduling carrier. The configuration of the base carrier and the dependent carrier for the downlink and the second configuration of the second base carrier and the second dependent carrier for the uplink may be independently determined for the UE. The linking between the base carrier and the dependent carrier for each link may be specific to the UE.

In one design, the scheduling grant may be one of a plurality of scheduling grant types available for use. The plurality of scheduling grant types may include at least one scheduling grant type (e.g., a common grant, a joint grant, etc.) available for scheduling multiple carriers via a single scheduling grant.

In one design, the scheduling grant may comprise a separate grant carrying first scheduling information for the base carrier. The UE may receive, on the scheduling carrier, a second scheduling grant comprising a second separate grant carrying second scheduling information for the dependent carrier. The UE may communicate on the base carrier based on scheduling grant and may communicate on the dependent carrier based on the second scheduling grant.

In another design, the scheduling grant may comprise a common grant carrying scheduling information that is common to both the base carrier and the dependent carrier. The scheduling information may comprise MCS information, HARQ information, and/or other information. The HARQ information may comprise a redundancy version, an HARQ process number, etc.

In yet another design, the scheduling grant may comprise a joint grant carrying first scheduling information for the base carrier and second scheduling information for the dependent carrier. The first and second scheduling information may each comprise MCS information, HARQ information, and/or other information. The first and second scheduling information may comprise the same set of parameters or different sets of parameters (e.g., as shown in FIG. 6). The second scheduling information may comprise an indication of whether or not the dependent carrier is scheduled for data transmission. The first scheduling information may comprise a field (e.g., CIF) that may be set to an invalid value if the base carrier is not scheduled for data transmission.

In yet another design, the scheduling grant may be one of a plurality of scheduling grant types available for scheduling data transmissions on the base carrier and the dependent carrier. The scheduling grant type may change dynamically, e.g., from subframe to subframe. In this case, the UE may perform blind detection to monitor for scheduling grants of different types. Alternatively, the scheduling grant type may be semi-statically configured for the UE. The UE may then monitor for scheduling grants of the scheduling grant type configured for the UE.

In one design, the scheduling grant does not include resource allocation information for the dependent carrier. The resource allocation for the dependent carrier may be known a priori by the UE. For example, the entire bandwidth of the dependent carrier may be scheduled for data transmission whenever the dependent carrier is scheduled. In another design, the scheduling grant may include resource allocation information for the dependent carrier. The granularity of resource allocation for the dependent carrier may be the same as, or different from, the granularity of resource allocation for the base carrier.

In one design of block 718, for common HARQ, the UE may send or receive a transport block on both the base carrier and the dependent carrier. In another design, for separate HARQ, the UE may send or receive a first transport block on the base carrier and may send or receive a second transport block on the dependent carrier.

In one design, the UE may receive DCI for both the base carrier and the dependent carrier on a primary carrier for the downlink for the UE. The UE may send UCI for both the base carrier and the dependent carrier on a primary carrier for the uplink for the UE. The UCI may comprise ACK/NACK, CSI, and/or other control information.

In one design, ACK/NACK may be common for both the base carrier and the dependent carrier. This design may be especially applicable for common HARQ. In another design, ACK/NACK for the base carrier may be separate from ACK/NACK for the dependent carrier. This design may be especially applicable for separate HARQ. The UE may determine first ACK/NACK for a first data transmission received on the base carrier and may also determine second ACK/NACK for a second data transmission received on the dependent carrier. The UE may send the common ACK/NACK for both carriers or separate ACK/NACK for the two carriers on the primary carrier for the uplink. In one design, ACK/NACK resources for sending ACK/NACK for the base carrier and the dependent carrier may be configured for the UE via upper-layer signaling. In another design, ACK/NACK resources for sending ACK/NACK for the base carrier and the dependent carrier may be implicitly conveyed, e.g., via the scheduling grant.

In one design, the UE may report CSI for the base carrier and the dependent carrier based on a CSI reporting configuration for both carriers. In another design, the UE may report CSI for each carrier based on a CSI reporting configuration for that carrier. In this design, the UE may receive a first CSI reporting configuration for the base carrier and a second CSI reporting configuration for the dependent carrier. The UE may send CSI for the base carrier in accordance with the first CSI reporting configuration and may send CSI for the dependent carrier in accordance with the second CSI reporting configuration.

In one design, the UE may determine CSI for the combined bandwidth of the base carrier and the dependent carrier. In another design, the UE may determine CSI separately for the base carrier and the dependent carrier. The same or different CSI reporting types may be supported for the two carriers. For example, the CSI for the dependent carrier may comprise only wideband CSI, and the CSI for the base carrier may comprise wideband CSI and/or subband CSI. The UE may send the CSI for the base carrier and the CSI for the dependent carrier in a single CSI report. Alternatively, the UE may send the CSI for the base carrier and the CSI the dependent carrier in separate CSI reports. The UE may determine that two CSI reports are scheduled to be sent for both the base carrier and the dependent carrier in the same subframe. The UE may prioritize the CSI reports based on a report type of each of the CSI reports, a carrier index of each of the base carrier and the dependent carrier, and/or other factors.

In one design, the UE may transmit SRS on the base carrier and the dependent carrier based on a single SRS configuration for both carriers. This SRS configuration may comprise a periodicity, an offset, and possibly a bandwidth for transmitting SRS on the base carrier and the dependent carrier. In another design, the UE may transmit SRS on each carrier based on an SRS configuration for that carrier. In this design, the UE may receive a first SRS configuration for the base carrier and a second SRS configuration for the dependent carrier. The UE may transmit SRS on the base carrier in accordance with the first SRS configuration and may transmit SRS on the dependent carrier in accordance with the second SRS configuration. The first SRS configuration may comprise a first periodicity, a first offset, and a bandwidth for transmitting SRS on the base carrier. The second SRS configuration may comprise a second periodicity and a second offset for transmitting SRS on the dependent carrier. SRS may be transmitted across entire bandwidth of the dependent carrier or may be transmit over a second bandwidth that may be conveyed by the first or second SRS configuration. In yet another design, the UE may receive a request to transmit an SRS, e.g., via the scheduling grant. The UE may then transmit the SRS on the dependent carrier in response to the request.

In one design, the UE may perform power control jointly for the base carrier and the dependent carrier. The UE may adjust the transmit power of the base carrier and the transmit power of the dependent carrier in the same manner based on TPC commands for both carriers. In another design, the UE may perform power control separately for the base carrier and the dependent carrier. The UE may adjust the transmit power of each carrier based on TPC commands for that carrier.

The base carrier may be configured for a first transmission mode, and the dependent carrier may be configured for a second transmission mode. In one design, the second transmission mode may be different from the first transmission mode. For example, the first transmission mode may be a MIMO transmission mode, and second transmission mode may be a non-MIMO transmission mode. In another design, the second transmission mode may be the same as the first transmission mode.

In one design, the dependent carrier may have a bandwidth that is smaller than the smallest possible bandwidth of a standalone carrier, e.g., the base carrier. The base carrier and the dependent carrier may be contiguous in frequency (e.g., as shown in FIG. 3A) or may be non-contiguous in frequency (e.g., as shown in FIG. 3C). The dependent carrier may comprise a single contiguous frequency segment (e.g., as shown in FIG. 3A) or multiple non-contiguous frequency segments (e.g., as shown in FIG. 3D). At least one additional dependent carrier may also be linked to the base carrier (e.g., as shown in FIG. 3D).

The base carrier and the dependent carrier may be in the same band or different bands. The base carrier and the dependent carrier may be served by a single base station. Alternatively, the base carrier and the dependent carrier may be served by two base stations located at different sites. The dependent carrier may be activated when the base carrier is activated and may be deactivated when the base carrier is deactivated.

FIG. 8 shows a design of a process 800 for supporting communication with carrier extension. Process 800 may be performed by a base station/eNB (as described below) or by some other entity. The base station may determine a configuration of a base carrier and a dependent carrier for a UE (block 812). The dependent carrier may be linked to the base carrier. Data transmission on the dependent carrier may be scheduled via a scheduling carrier that is different from the dependent carrier. The base station may generate a scheduling grant for the base carrier, or the dependent carrier, or both the base carrier and the dependent carrier (block 814). The base station may send the scheduling grant on the scheduling carrier to the UE (block 816). The base station may communicate with the UE on the base carrier and/or the dependent carrier based on the scheduling grant (block 818).

The base carrier and the dependent carrier may be for the downlink. The base station may determine a second configuration of a second base carrier and a second dependent carrier for the uplink for the UE. Downlink data transmission on the dependent carrier and uplink data transmission on the second dependent carrier may be scheduled via the scheduling carrier.

In one design, the scheduling grant may comprise a separate grant carrying first scheduling information for the base carrier. The base station may send a second scheduling grant on the scheduling carrier to the UE. The second scheduling grant may comprise a second separate grant carrying second scheduling information for the dependent carrier. The base station may communicate with the UE on the base carrier based on scheduling grant and may communicate with the UE on the dependent carrier based on the second scheduling grant.

In another design, the scheduling grant may comprise a common grant carrying scheduling information common to both the base carrier and the dependent carrier. In yet another design, the scheduling grant may comprise a joint grant carrying first scheduling information for the base carrier and second scheduling information for the dependent carrier. In yet another design, the scheduling grant may be one of a plurality of scheduling grant types available for scheduling data transmissions on the base carrier and the dependent carrier.

The base station may send DCI for both the base carrier and the dependent carrier on a primary carrier for the downlink to the UE. The base station may receive UCI for both the base carrier and the dependent carrier sent by the UE on a primary carrier for the uplink. The base station may receive ACK/NACK, CSI, and SRS from the UE as described above. The base station may also perform power control for the base carrier and the dependent carrier as also described above.

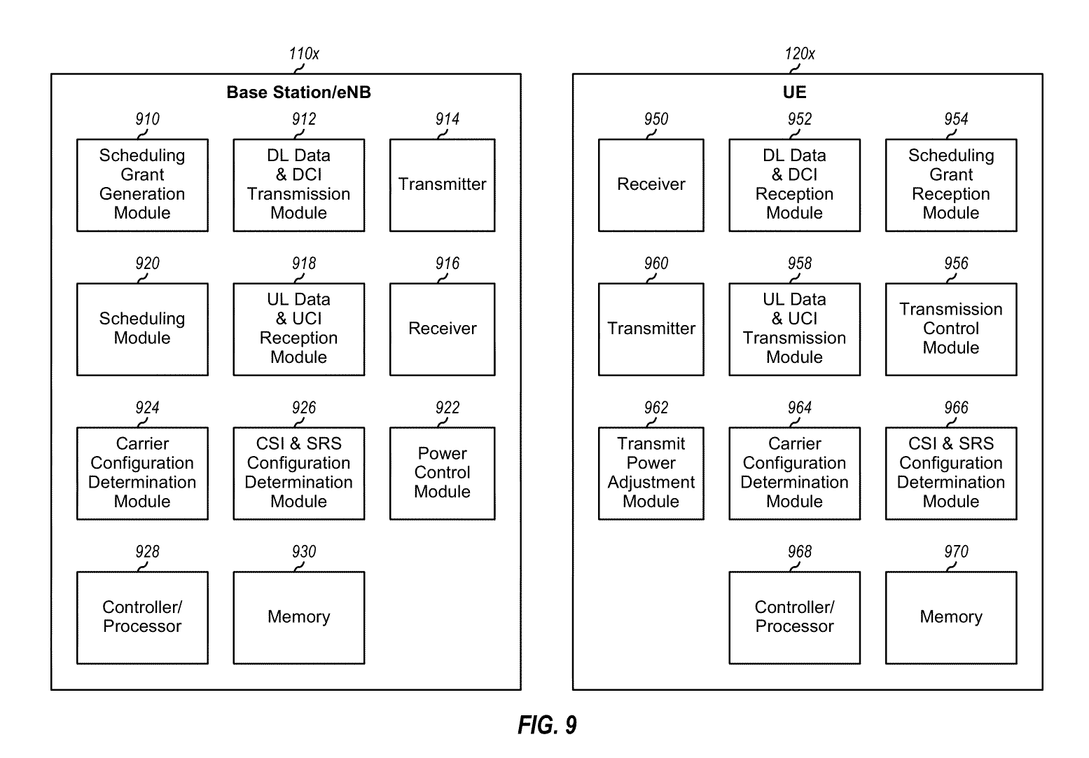

FIG. 9 shows a block diagram of a design of a base station/eNB 110x and a UE 120x, which may be one of the base stations/eNBs and one of the UEs in FIG. 1. Within base station 110x, a module 910 may generate scheduling grants (e.g., separate grants, common grants, joint grants, combination grants, etc.) for UE 120x and other UEs. A module 912 may process DL data and DCI (e.g., scheduling grants, DL ACK/NACK, etc.) to generate DL transmissions on DL carriers, which may include a DL base carrier and one or more DL dependent carriers for UE 120x. A transmitter 914 may generate a downlink signal comprising the DL transmissions. A receiver 916 may receive and process uplink signals transmitted by UE 120x and other UEs. A module 918 may process a received signal for UL transmissions sent on UL carriers (which may include an UL base carrier and one or more UL dependent carriers for UE 120x) to recover UL data and UCI sent by UE 120x and other UEs.

A module 924 may determine a carrier configuration of UE 120x, e.g., determine which carriers are configured for UE 120x for the downlink and uplink, and linkage of dependent carriers to base carriers. A module 920 may schedule UE 120x for data transmission on the downlink and/or uplink based on the carriers configured for UE 120x. A module 926 may determine CSI reporting configurations and/or SRS configurations of UE 120x and other UEs. Module 918 may receive periodic CSI and SRS from UE 120x based on the CSI reporting configuration(s) and the SRS configuration(s) for the base carriers and dependent carriers for UE 120x. A module 922 may perform power control for UE 120x and other UEs. The various modules within base station 110x may operate as described above. A controller/processor 928 may direct the operation of various modules within base station 110x. A memory 930 may store data and program codes for base station 110x.

Within UE 120x, a receiver 950 may receive and process downlink signals from base station 110x and other base stations. A module 952 may process (e.g., demodulate and decode) a received signal to recover DL data and DCI sent to UE 120x. A module 954 may receive scheduling grants for UE 120x. A module 956 may control data transmission on the uplink and data reception on the downlink based on the scheduling grants received for UE 120x. A module 958 may process UL data and UCI (e.g., UL ACK/NACK, CSI, etc.) to generate UL transmissions on an UL base carrier and one or more UL dependent carriers for UE 120x. A transmitter 960 may generate an uplink signal comprising the UL transmissions.

A module 964 may determine a carrier configuration of UE 120x, e.g., determine which carriers are configured for UE 120x for the downlink and uplink, and linkage of dependent carriers to base carriers for UE 120x. A module 966 may determine CSI reporting configuration(s) and SRS configuration(s) of UE 120x. Module 958 may send periodic CSI and SRS based on the CSI reporting configuration(s) and the SRS configuration(s) for the base carriers and dependent carriers for UE 120x. A module 962 may adjust the transmit power of UE 120x. The various modules within UE 120x may operate as described above. A controller/processor 968 may direct the operation of various modules within UE 120x. A memory 970 may store data and program codes for UE 120x.

The modules in FIG. 9 may comprise processors, electronic devices, hardware devices, electronic components, logical circuits, memories, software codes, firmware codes, etc., or any combination thereof.

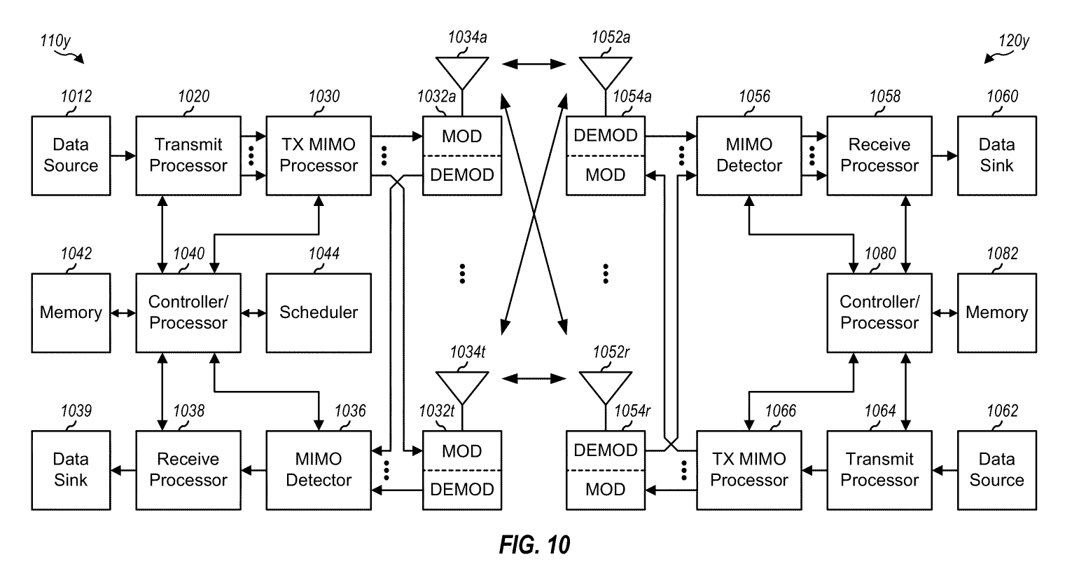

FIG. 10 shows a block diagram of a design of a base station/eNB 110y and a UE 120y, which may be one of the base stations/eNBs and one of the UEs in FIG. 1. Base station 110y may be equipped with T antennas 1034a through 1034t, and UE 120y may be equipped with R antennas 1052a through 1052r, where in general T≧1 and R≧1.

At base station 110y, a transmit processor 1020 may receive data from a data source 1012 for transmission on one or more DL carriers to one or more UEs, process (e.g., encode and modulate) the data for each UE based on one or more modulation and coding schemes selected for that UE, and provide data symbols for all UEs. Transmit processor 1020 may also process DCI (e.g., for scheduling grants, DL ACK/NACK, configuration messages, etc.) and provide control symbols. Processor 1020 may also generate reference symbols for reference signals. A transmit (TX) MIMO processor 1030 may precode the data symbols, the control symbols, and/or the reference symbols (if applicable) and may provide T output symbol streams to T modulators (MOD) 1032a through 1032t. Each modulator 1032 may process its output symbol stream (e.g., for OFDM, etc.) to obtain an output sample stream. Each modulator 1032 may further condition (e.g., convert to analog, amplify, filter, and upconvert) its output sample stream to obtain a downlink signal. T downlink signals from modulators 1032a through 1032t may be transmitted via T antennas 1034a through 1034t, respectively.

At UE 120y, antennas 1052a through 1052r may receive the downlink signals from base station 110y and/or other base stations and may provide received signals to demodulators (DEMODs) 1054a through 1054r, respectively. Each demodulator 1054 may condition (e.g., filter, amplify, downconvert, and digitize) its received signal to obtain input samples. Each demodulator 1054 may further process the input samples (e.g., for OFDM, etc.) to obtain received symbols. A MIMO detector 1056 may obtain received symbols from all R demodulators 1054a through 1054r, perform MIMO detection on the received symbols, and provide detected symbols. A receive processor 1058 may process (e.g., demodulate and decode) the detected symbols, provide decoded data for UE 120y to a data sink 1060, and provide decoded DCI to a controller/processor 1080.

On the uplink, at UE 120y, a transmit processor 1064 may receive and process data from a data source 1062 and UCI (e.g., UL ACK/NACK, CSI, etc.) from controller/processor 1080. Processor 1064 may also generate reference symbols for one or more reference signals (e.g., SRS). The symbols from transmit processor 1064 may be precoded by a TX MIMO processor 1066 if applicable, further processed by modulators 1054a through 1054r (e.g., for SC-FDM, OFDM, etc.), and transmitted to base station 110y. At base station 110y, the uplink signals from UE 120y and other UEs may be received by antennas 1034, processed by demodulators 1032, detected by a MIMO detector 1036 if applicable, and further processed by a receive processor 1038 to obtain decoded data and control information sent by UE 120y and other UEs. Processor 1038 may provide the decoded data to a data sink 1039 and the decoded UCI to controller/processor 1040.

Controllers/processors 1040 and 1080 may direct the operation at base station 110y and UE 120y, respectively. Processor 1040 and/or other processors and modules at base station 110y may perform or direct process 800 in FIG. 8 and/or other processes for the techniques described herein. Processor 1080 and/or other processors and modules at UE 120y may perform or direct process 700 in FIG. 7 and/or other processes for the techniques described herein. Memories 1042 and 1082 may store data and program codes for base station 110y and UE 120y, respectively. A scheduler 1044 may schedule UEs for data transmission on the downlink and/or uplink.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
receiving a configuration of a base carrier and a dependent carrier for a user equipment (UE), wherein data transmission on the dependent carrier is scheduled via a scheduling carrier different from the dependent carrier;
receiving a scheduling grant on the scheduling carrier;
determining whether the scheduling grant is for the base carrier, or the dependent carrier, or both the base carrier and the dependent carrier; and
communicating on the base carrier, or the dependent carrier, or both based on the scheduling grant.

2. The method of claim 1, wherein the scheduling grant is one of a plurality of scheduling grant types available for use, the plurality of scheduling grant types including at least one scheduling grant type available for scheduling multiple carriers via a single scheduling grant.

3. The method of claim 1, wherein the scheduling grant comprises a common grant carrying scheduling information common to both the base carrier and the dependent carrier.

4. The method of claim 3, wherein the scheduling information comprises at least one of modulation and coding scheme (MCS) information and hybrid automatic repeat request (HARQ) information.

5. The method of claim 1, wherein the scheduling grant comprises a joint grant carrying first scheduling information for the base carrier and second scheduling information for the dependent carrier.

6. The method of claim 5, wherein the first and second scheduling information each comprises at least one of modulation and coding scheme (MCS) information and hybrid automatic repeat request (HARQ) information.

7. The method of claim 5, wherein the second scheduling information comprises an indication of whether or not the dependent carrier is scheduled for data transmission.

8. The method of claim 5, further comprising:
determining that the base carrier is not scheduled for data transmission when an invalid value is detected in the first scheduling information.

9. The method of claim 1, wherein the scheduling grant comprises a separate grant carrying first scheduling information for the base carrier, the method further comprising:
receiving a second scheduling grant on the scheduling carrier, the second scheduling grant comprising a second separate grant carrying second scheduling information for the dependent carrier;
communicating on the base carrier based on scheduling grant; and
communicating on the dependent carrier based on the second scheduling grant.

10. The method of claim 1, further comprising:
determining a scheduling grant type configured for the UE and selected from a plurality of scheduling grant types; and
monitoring for scheduling grants of the scheduling grant type configured for the UE.

11. The method of claim 10, wherein the scheduling grant type configured for the UE changes dynamically or is semi-statically configured for the UE via upper layer signaling.

12. The method of claim 1, wherein the communicating on the base carrier, or the dependent carrier, or both comprises sending or receiving a transport block on both the base carrier and the dependent carrier.

13. The method of claim 1, wherein the communicating on the base carrier, or the dependent carrier, or both comprises
sending or receiving a first transport block on the base carrier, and
sending or receiving a second transport block on the dependent carrier.

14. The method of claim 1, further comprising:
receiving downlink control information (DCI) for both the base carrier and the dependent carrier on a primary carrier for downlink.

15. The method of claim 1, further comprising:
sending uplink control information (UCI) for both the base carrier and the dependent carrier on a primary carrier for uplink.

16. The method of claim 15, wherein the UCI comprises at least one of acknowledgement/negative acknowledgement (ACK/NACK) and channel state information (CSI).

17. The method of claim 1, further comprising:
determining first acknowledgement/negative acknowledgement (ACK/NACK) for a first data transmission received on the base carrier based on the scheduling grant;
determining second ACK/NACK for a second data transmission received on the dependent carrier based on the scheduling grant; and
sending the first and second ACK/NACK on a primary carrier for uplink.

18. The method of claim 1, further comprising:
receiving a first channel state information (CSI) reporting configuration for the base carrier;
receiving a second CSI reporting configuration for the dependent carrier;
sending CSI for the base carrier in accordance with the first CSI reporting configuration; and
sending CSI for the dependent carrier in accordance with the second CSI reporting configuration.

19. The method of claim 1, further comprising:
receiving a channel state information (CSI) reporting configuration for both the base carrier and the dependent carrier; and
sending CSI for the base carrier and the dependent carrier in accordance with the CSI reporting configuration.

20. The method of claim 1, further comprising:
receiving a first sounding reference signal (SRS) configuration for the base carrier;
receiving a second SRS configuration for the dependent carrier;
transmitting SRS on the base carrier in accordance with the first SRS configuration; and
transmitting SRS on the dependent carrier in accordance with the second SRS configuration.

21. The method of claim 1, further comprising:
receiving a sounding reference signal (SRS) configuration for both the base carrier and the dependent carrier; and
transmitting SRS on the base carrier and the dependent carrier in accordance with the SRS configuration.

22. The method of claim 1, further comprising:
receiving a request to transmit a sounding reference signal (SRS); and
transmitting the SRS on the dependent carrier in response to the request.

23. The method of claim 1, further comprising:
performing power control jointly or separately for the base carrier and the dependent carrier.

24. The method of claim 1, wherein the base carrier is configured for a first transmission mode, and wherein the dependent carrier is configured for a second transmission mode different from the first transmission mode.

25. The method of claim 1, wherein the base carrier and the dependent carrier are for downlink communication, the method further comprising:
receiving a second configuration of a second base carrier and a second dependent carrier for uplink communication, wherein downlink data transmission on the dependent carrier and uplink data transmission on the second dependent carrier are scheduled via the scheduling carrier.

26. The method of claim 1, wherein the dependent carrier has a bandwidth that is smaller than a smallest possible bandwidth of the base carrier.

27. An apparatus for wireless communication, comprising:
at least one processor configured to:
receive a configuration of a base carrier and a dependent carrier for a user equipment (UE), wherein data transmission on the dependent carrier is scheduled via a scheduling carrier different from the dependent carrier;
receive a scheduling grant on the scheduling carrier;
determine whether the scheduling grant is for the base carrier, or the dependent carrier, or both the base carrier and the dependent carrier; and
communicate on the base carrier, or the dependent carrier, or both based on the scheduling grant.

28. The apparatus of claim 27, wherein the scheduling grant is one of a plurality of scheduling grant types available for use, the plurality of scheduling grant types including at least one scheduling grant type available for scheduling multiple carriers via a single scheduling grant.

29. The apparatus of claim 27, wherein the scheduling grant comprises a common grant carrying scheduling information common to both the base carrier and the dependent carrier.

30. The apparatus of claim 27, wherein the scheduling grant comprises a joint grant carrying first scheduling information for the base carrier and second scheduling information for the dependent carrier.

31. The apparatus of claim 27, wherein the scheduling grant comprises a separate grant carrying first scheduling information for the base carrier, and wherein the at least one processor is configured to:
receive a second scheduling grant on the scheduling carrier, the second scheduling grant comprising a second separate grant carrying second scheduling information for the dependent carrier;
communicate on the base carrier based on scheduling grant; and
communicate on the dependent carrier based on the second scheduling grant.

32. An apparatus for wireless communication, comprising:
means for receiving a configuration of a base carrier and a dependent carrier for a user equipment (UE), wherein data transmission on the dependent carrier is scheduled via a scheduling carrier different from the dependent carrier;
means for receiving a scheduling grant on the scheduling carrier;
means for determining whether the scheduling grant is for the base carrier, or the dependent carrier, or both the base carrier and the dependent carrier; and
means for communicating on the base carrier, or the dependent carrier, or both based on the scheduling grant.

33. The apparatus of claim 32, wherein the scheduling grant is one of a plurality of scheduling grant types available for use, the plurality of scheduling grant types including at least one scheduling grant type available for scheduling multiple carriers via a single scheduling grant.

34. The apparatus of claim 32, wherein the scheduling grant comprises a common grant carrying scheduling information common to both the base carrier and the dependent carrier.

35. The apparatus of claim 32, wherein the scheduling grant comprises a joint grant carrying first scheduling information for the base carrier and second scheduling information for the dependent carrier.

36. The apparatus of claim 32, wherein the scheduling grant comprises a separate grant carrying first scheduling information for the base carrier, the apparatus further comprising:
means for receiving a second scheduling grant on the scheduling carrier, the second scheduling grant comprising a second separate grant carrying second scheduling information for the dependent carrier;
means for communicating on the base carrier based on scheduling grant; and
means for communicating on the dependent carrier based on the second scheduling grant.

37. A computer program product, comprising:
a non-transitory computer-readable medium comprising:
code for causing at least one processor to receive a configuration of a base carrier and a dependent carrier for a user equipment (UE), wherein data transmission on the dependent carrier is scheduled via a scheduling carrier different from the dependent carrier;
code for causing the at least one processor to receive a scheduling grant on the scheduling carrier;
code for causing the at least one processor to determine whether the scheduling grant is for the base carrier, or the dependent carrier, or both the base carrier and the dependent carrier; and
code for causing the at least one processor to communicate on the base carrier, or the dependent carrier, or both based on the scheduling grant.

38. A method for wireless communication, comprising:
determining a configuration of a base carrier and a dependent carrier for a user equipment (UE), wherein data transmission on the dependent carrier is scheduled via a scheduling carrier different from the dependent carrier;
generating a scheduling grant for the base carrier, or the dependent carrier, or both the base carrier and the dependent carrier;
sending the scheduling grant on the scheduling carrier to the UE; and
communicating with the UE on the base carrier, or the dependent carrier, or both based on the scheduling grant.

39. The method of claim 38, wherein the scheduling grant is one of a plurality of scheduling grant types available for use, the plurality of scheduling grant types including at least one scheduling grant type available for scheduling multiple carriers via a single scheduling grant.

40. The method of claim 38, wherein the scheduling grant comprises a common grant carrying scheduling information common to both the base carrier and the dependent carrier.

41. The method of claim 38, wherein the scheduling grant comprises a joint grant carrying first scheduling information for the base carrier and second scheduling information for the dependent carrier.

42. The method of claim 38, wherein the scheduling grant comprises a separate grant carrying first scheduling information for the base carrier, the method further comprising:
sending a second scheduling grant on the scheduling carrier to the UE, the second scheduling grant comprising a second separate grant carrying second scheduling information for the dependent carrier;
communicating with the UE on the base carrier based on scheduling grant; and
communicating with the UE on the dependent carrier based on the second scheduling grant.

43. The method of claim 38, wherein the base carrier and the dependent carrier are for downlink, the method further comprising:
determining a second configuration of a second base carrier and a second dependent carrier for uplink for the UE, wherein downlink data transmission on the dependent carrier and uplink data transmission on the second dependent carrier are scheduled via the scheduling carrier.

44. The method of claim 38, further comprising:
sending downlink control information (DCI) for both the base carrier and the dependent carrier on a primary carrier for downlink to the UE.

45. The method of claim 38, further comprising:
receiving uplink control information (UCI) for both the base carrier and the dependent carrier sent by the UE on a primary carrier for uplink.

46. An apparatus for wireless communication, comprising:
at least one processor configured to:
determine a configuration of a base carrier and a dependent carrier for a user equipment (UE), wherein data transmission on the dependent carrier is scheduled via a scheduling carrier different from the dependent carrier;
generate a scheduling grant for the base carrier, or the dependent carrier, or both the base carrier and the dependent carrier;
send the scheduling grant on the scheduling carrier to the UE; and
communicate with the UE on the base carrier, or the dependent carrier, or both based on the scheduling grant.

47. The apparatus of claim 46, wherein the scheduling grant is one of a plurality of scheduling grant types available for use, the plurality of scheduling grant types including at least one scheduling grant type available for scheduling multiple carriers via a single scheduling grant.

48. The apparatus of claim 46, wherein the scheduling grant comprises a common grant carrying scheduling information common to both the base carrier and the dependent carrier.

49. The apparatus of claim 46, wherein the scheduling grant comprises a joint grant carrying first scheduling information for the base carrier and second scheduling information for the dependent carrier.

50. The apparatus of claim 46, wherein the scheduling grant comprises a separate grant carrying first scheduling information for the base carrier, and wherein the at least one processor is configured to:
send a second scheduling grant on the scheduling carrier to the UE, the second scheduling grant comprising a second separate grant carrying second scheduling information for the dependent carrier;
communicate with the UE on the base carrier based on scheduling grant; and
communicate with the UE on the dependent carrier based on the second scheduling grant.

51. An apparatus for wireless communication, comprising:
means for determining a configuration of a base carrier and a dependent carrier for a user equipment (UE), wherein data transmission on the dependent carrier is scheduled via a scheduling carrier different from the dependent carrier;
means for generating a scheduling grant for the base carrier, or the dependent carrier, or both the base carrier and the dependent carrier;
means for sending the scheduling grant on the scheduling carrier to the UE; and
means for communicating with the UE on the base carrier, or the dependent carrier, or both based on the scheduling grant.

52. The apparatus of claim 51, wherein the scheduling grant is one of a plurality of scheduling grant types available for use, the plurality of scheduling grant types including at least one scheduling grant type available for scheduling multiple carriers via a single scheduling grant.

53. The apparatus of claim 51, wherein the scheduling grant comprises a common grant carrying scheduling information common to both the base carrier and the dependent carrier.

54. The apparatus of claim 51, wherein the scheduling grant comprises a joint grant carrying first scheduling information for the base carrier and second scheduling information for the dependent carrier.

55. The apparatus of claim 51, wherein the scheduling grant comprises a separate grant carrying first scheduling information for the base carrier, the apparatus further comprising:
means for sending a second scheduling grant on the scheduling carrier to the UE, the second scheduling grant comprising a second separate grant carrying second scheduling information for the dependent carrier;
means for communicating with the UE on the base carrier based on scheduling grant; and
means for communicating with the UE on the dependent carrier based on the second scheduling grant.

56. A computer program product, comprising:
a non-transitory computer-readable medium comprising:
code for causing at least one processor to determine a configuration of a base carrier and a dependent carrier for a user equipment (UE), wherein data transmission on the dependent carrier is scheduled via a scheduling carrier different from the dependent carrier;
code for causing the at least one processor to generate a scheduling grant for the base carrier, or the dependent carrier, or both the base carrier and the dependent carrier;
code for causing the at least one processor to send the scheduling grant on the scheduling carrier to the UE; and
code for causing the at least one processor to communicate with the UE on the base carrier, or the dependent carrier, or both based on the scheduling grant.
